(19) United States
(12) Patent Application Publication
(10) Pub. No.: US 2025/0265253 A1
(43) Pub. Date: Aug. 21, 2025

(54) AUTOMATIC RETRIEVAL AUGMENTED GENERATION WITH EXPANDING CONTEXT

(71) Applicant: Cisco Technology, Inc., San Jose, CA (US)

(72) Inventors: Advit DEEPAK, San Jose, CA (US); William HEALY, Riverside, CT (US); Tarun RAHEJA, Philadelphia, PA (US); Jayanth SRINIVASA, San Jose, CA (US); Ramana Rao V. R. KOMPELLA, Foster City, CA (US); Raunak SINHA, Los Angeles, CA (US)

(73) Assignee: Cisco Technology, Inc., San Jose, CA (US)

(21) Appl. No.: 18/442,996

(22) Filed: Feb. 15, 2024

(51) Int. Cl. G06F 16/2457; G06F 16/242

(52) U.S. Cl. CPC G06F 16/24578; G06F 16/2425

(57) ABSTRACT

In one embodiment, a method herein may comprise: fetching relevant context responsive to a particular query initially submitted into a large language model without additional context; determining that an output from the large language model for the particular query is an unacceptable output; providing, responsive to the unacceptable output, a select portion of the relevant context to the large language model for a subsequent output; and increasing, progressively and responsive to subsequent unacceptable outputs from the large language model, an amount of context in each subsequent portion iteratively provided to the large language model until an acceptable output is achieved.

### TECHNICAL FIELD

The present disclosure relates generally to computer networks, and, more particularly, to automatic retrieval augmented generation (RAG) with expanding context.

### BACKGROUND

The recent breakthroughs in large language models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

A downside to a pure LLM is that its performance can be inconsistent and can sometimes provide incorrect answers without any insight into how it arrived at a given answer. To address this, retrieval augmented generation (RAG) has arisen. In general, RAG operates by performing a search based on a user's prompt for additional context, thereby augmenting the prompt with more context for input to the LLM. However, RAG is not without additional costs and the more context provided, the greater the processing costs.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example architecture for automatic retrieval augmented generation (RAG) with expanding context;

FIG. 4 illustrates an example user interface for the automatic RAG with expanding context; and

FIG. 5 illustrates an example procedure for automatic RAG with expanding context.

### DESCRIPTION OF EXAMPLE EMBODIMENTS

### Overview

According to one or more embodiments of the disclosure, a method herein may comprise: fetching, by a device, relevant context responsive to a particular query initially submitted into a large language model without additional context; determining, by the device, that an output from the large language model for the particular query is an unacceptable output; providing, by the device and responsive to the unacceptable output, a select portion of the relevant context to the large language model for a subsequent output; and increasing, by the device, progressively and responsive to subsequent unacceptable outputs from the large language model, an amount of context in each subsequent portion iteratively provided to the large language model until an acceptable output is achieved.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

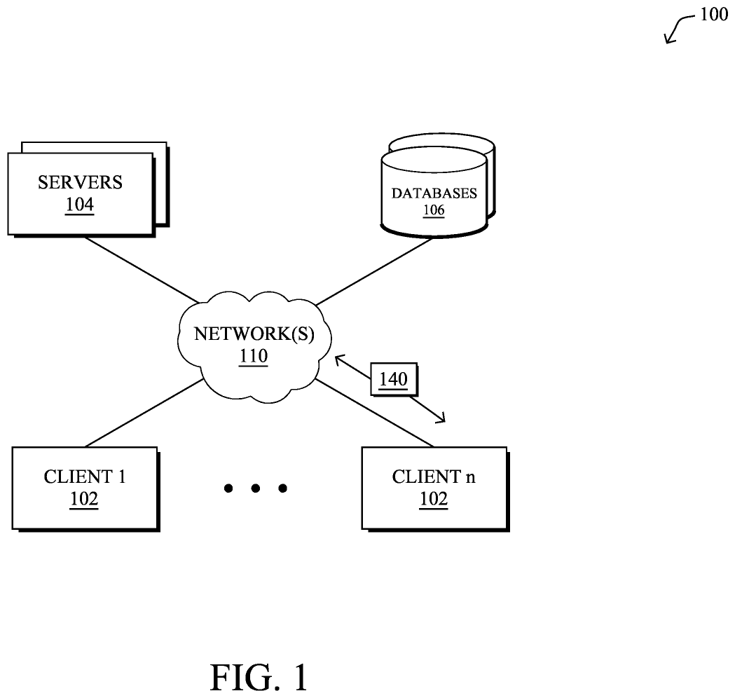

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

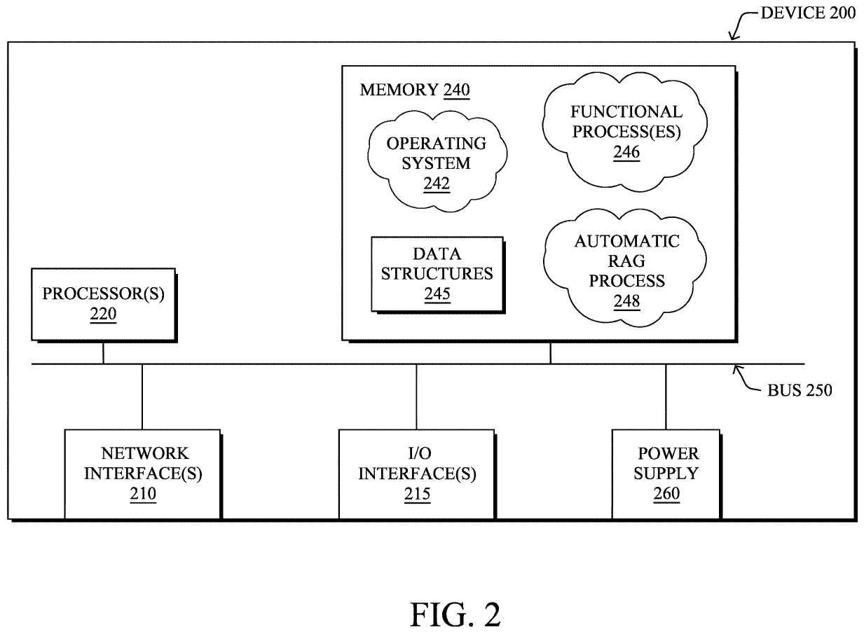

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an automatic RAG process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, automatic RAG process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

——Automatic RAG with Expanding Context——

As noted above, large language models (LLMs) represent new opportunities across a wide spectrum of industries, yet a downside to a pure LLM is that its performance can be inconsistent and can sometimes provide incorrect answers without any insight into how it arrived at a given answer. As also noted above, retrieval augmented generation (RAG) in an existing technique that address this by performing a search based on a user's prompt for additional context, thereby augmenting the prompt with more context for input to the LLM. However, RAG is not without additional costs and the more context provided, the greater the processing costs.

The techniques herein, therefore, provide for automatic retrieval augmented generation (RAG) with expanding context. In particular, the system herein allows for the use of RAG for a large language model (LLM) with progressively expanding context, taking a conservative approach to providing context and increasing the amount of context when the user is unsatisfied with the output of the LLM.

Specifically, according to one or more embodiments of the disclosure as described in detail below, a method herein may comprise: fetching relevant context responsive to a particular query initially submitted into a large language model without additional context; determining that an output from the large language model for the particular query is an unacceptable output; providing, responsive to the unacceptable output, a select portion of the relevant context to the large language model for a subsequent output; and increasing, progressively and responsive to subsequent unacceptable outputs from the large language model, an amount of context in each subsequent portion iteratively provided to the large language model until an acceptable output is achieved.

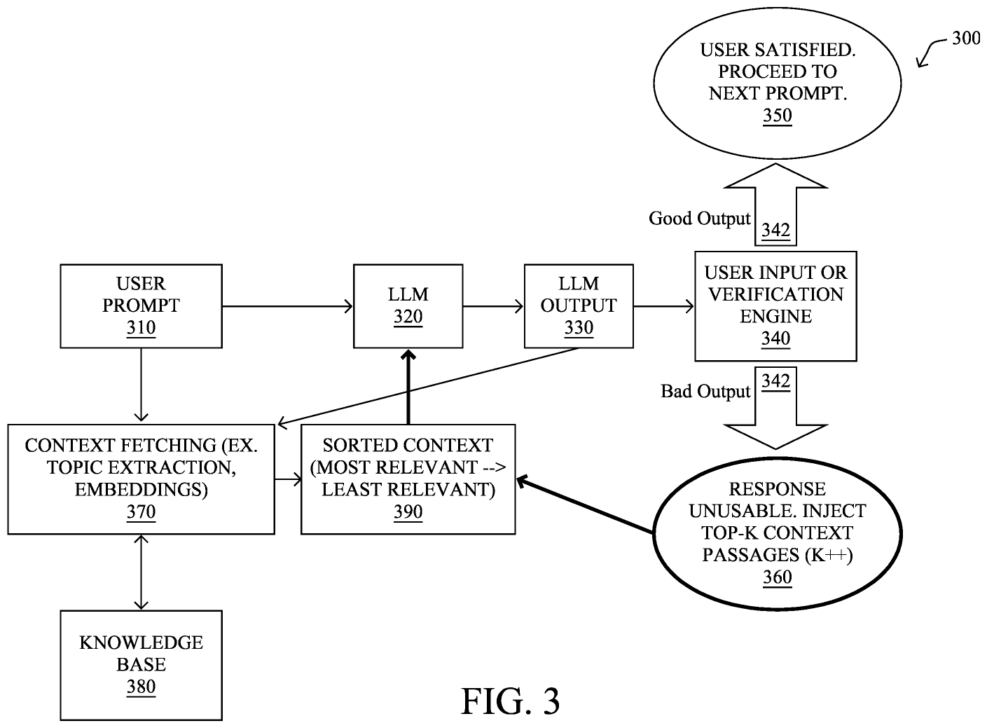

FIG. 3 illustrates an example of an architecture 300 for automatic retrieval augmented generation (RAG) with expanding context.

Operationally, the architecture 300 and the techniques herein have several key functionalities.
An LLM pipeline that passes a prompt 310 (e.g., a user prompt) to an LLM 320 to generate an LLM output 330.
A feedback mechanism 340 that allows an indication as to whether the LLM output is acceptable or not (e.g., feedback from user feedback or a verification engine).
A RAG mechanism that performs context fetching (context fetching 370) of a knowledge base 380 for a given prompt (e.g., prompt 310), and as described below, providing a sorted progressive context (sorted context 390) for expanding context.

In various implementations, the techniques herein propose that the system take a conservative approach to the amount of context provided as input to the LLM by the RAG mechanism of the system, increasing the amount of context when the output of the LLM are considered unsatisfactory to the user.

In particular, the above system (architecture 300) may be configured to operate as follows:
Stage 1: A user (or other automated system) queries the LLM 320 directly, with the system herein providing no additional context (i.e., “K=0”, where K is a counter of how many context passages to provide).
Stage 2: The system herein uses the prompt 310 and response (LLM output 330) to automatically fetch relevant context (context fetching 370) from the knowledge base 380. Context fetching, for instance, may be based on topic extraction, embeddings, and so on.
Stage 3: If the feedback mechanism 340 indicates that the user is unsatisfied with the output of the LLM, or if the output is deemed unusable by an external verification system (e.g., bad output feedback 342), a small portion of the most relevant context (from sorted context 390) is then provided to the LLM 320 along with the prompt 310 (e.g., the previous prompt, or a new prompt that responded to the unacceptable output).
Stage 4+: If the user is still unsatisfied, or if the output is still deemed unusable by an external verification system, larger and larger portions of the most relevant context is then iteratively provided to the LLM, accordingly.

This may continue to progressively increase the amount of context provided until an acceptable answer is indicated (good output feedback 341), where once the user is satisfied the system may proceed to process a next prompt (step 350).

In certain implementations herein, for each prompt, the amount of necessary context before the LLM produced an acceptable answer may be tracked and utilized to automatically provide a minimal amount of context if a topically-similar query is later asked.

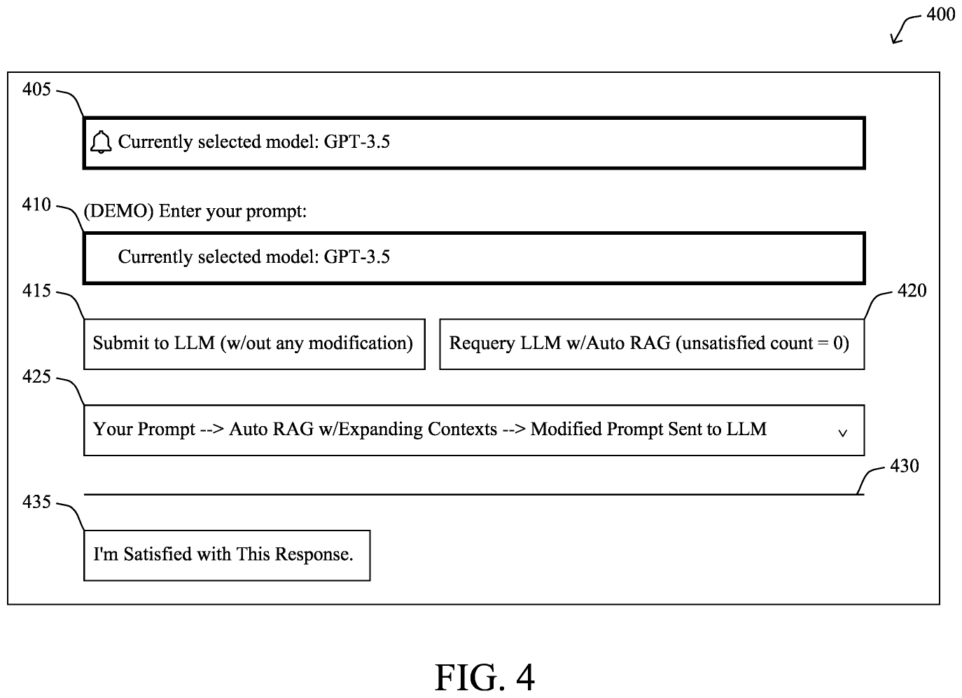

FIG. 4 illustrates an example of a user interface 400 for the automatic RAG with expanding context. For instance, as shown, a currently selected model 405 (e.g., GPT 3.5) may be used by an LLM to process language entered by a user (or other entry system) into input prompt 410. The user then has the option (option 415) to submit a new prompt without any modification (i.e., without any context-based modification by RAG), or else the option (option 420) to re-query the LLM with the automatic RAG herein (e.g., along with an indication of a current unsatisfied count, “K” above, to see a number of iterations currently taken for the input prompt 410).

A dropdown 425 may be configured to show a user how their prompt has been modified using auto-RAG with expanding contexts herein, i.e., what the modified prompt(s) sent to the LLM was (e.g., most immediate or a historical account) or what the next one would be if selected by the user.

An output field 430 is shown (blank in the example) where the response to input prompt may appear after it has been processed by the LLM. As described herein, a feedback prompt 435 (e.g., “I'm satisfied with this response” or otherwise) may be used to indicate a successful output (or alternatively or in addition, an unsuccessful output), at upon the selection of which the LLM can then process a new input prompt, accordingly.

Other formats of a user interface may be used, and other modified options may be added or removed from the user interface shown. For example, user feedback may be more conversational (e.g., in a chatbot setting) or other fields may also be provided, such as indicating a desired increase in context to override the iteratively progressive auto-RAG (e.g., to move faster to a successful response).

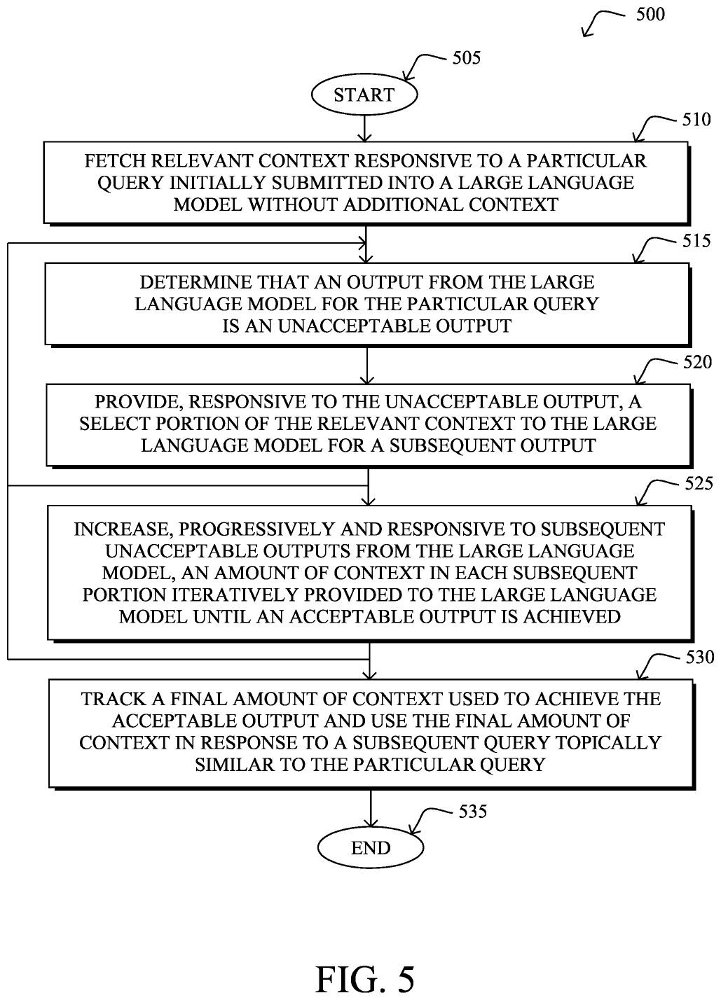

FIG. 5 illustrates an example simplified procedure for automatic RAG with expanding context in accordance with one or more embodiments described herein. For example, a non-generic, specifically configured device (e.g., device 200, an apparatus) may perform procedure 500 by executing stored instructions (e.g., process 248). The procedure 500 may start at step 505, and continues to step 510, where, as described in greater detail above, the techniques here (e.g., the RAG mechanism) fetches relevant context (e.g., from a knowledge base) responsive to a particular query (e.g., a user query) initially submitted into a large language model without additional context.

In step 515, the techniques herein may determine that an output from the large language model for the particular query is an unacceptable output. For example, as noted above, such a determination may be based on determining user dissatisfaction with the output (e.g., receiving a user selection regarding satisfaction, or receiving a conversational indication from a user regarding satisfaction, etc.), or else receiving an indication from a verification system (e.g., a verification system external to the device) that the output has been deemed unusable.

Responsive to the unacceptable output, the techniques herein in step 520 may then provide a select portion of the relevant context to the large language model for a subsequent output. In one embodiment, the techniques herein sort a plurality of portions of the relevant context according to relevance (e.g., most relevant to least relevant), and then provide the most relevant portion of the context, accordingly.

Responsive to subsequent unacceptable outputs from the large language model, in step 525, the techniques herein may progressively increase an amount of context in each subsequent portion iteratively provided to the large language model until an acceptable output is achieved. For instance, where the plurality of portions of the relevant context are sorted according to relevance, the techniques herein may provide the select portion and each subsequent portion iteratively in order of relevance.

Iterations of RAG with expanding context continue through procedure 500 in this manner until an acceptable output is achieved.

In one embodiment herein, in step 530, the system may also track a final amount of context used to achieve the acceptable output, in order to later use the final amount of context in response to a subsequent query topically similar to the particular query.

Procedure 500 may end at step 535.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: fetching relevant context responsive to a particular query initially submitted into a large language model without additional context; determining that an output from the large language model for the particular query is an unacceptable output; providing, responsive to the unacceptable output, a select portion of the relevant context to the large language model for a subsequent output; and increasing, progressively and responsive to subsequent unacceptable outputs from the large language model, an amount of context in each subsequent portion iteratively provided to the large language model until an acceptable output is achieved.

In still other implementations, a tangible, non-transitory, computer-readable medium storing program instructions that cause a device to execute a process comprising: fetching relevant context responsive to a particular query initially submitted into a large language model without additional context; determining that an output from the large language model for the particular query is an unacceptable output; providing, responsive to the unacceptable output, a select portion of the relevant context to the large language model for a subsequent output; and increasing, progressively and responsive to subsequent unacceptable outputs from the large language model, an amount of context in each subsequent portion iteratively provided to the large language model until an acceptable output is achieved.

The techniques described herein, therefore, provide for automatic retrieval augmented generation (RAG) with expanding context. In particular, the techniques herein not only use RAG to help increase the consistency of correct answers from LLMs by augmenting the prompt with more context for input to the LLM, but they also minimize the additional processing costs of RAG by intelligently minimizing the amount of context provided to the LLM.

Illustratively, the techniques described herein may be performed by hardware, software, and/or firmware, (e.g., an “apparatus”) such as in accordance with the automatic RAG process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
fetching, by a device, relevant context responsive to a particular query initially submitted into a large language model without additional context;
determining, by the device, that an output from the large language model for the particular query is an unacceptable output;
providing, by the device and responsive to the unacceptable output, a select portion of the relevant context to the large language model for a subsequent output; and
increasing, by the device, progressively and responsive to subsequent unacceptable outputs from the large language model, an amount of context in each subsequent portion iteratively provided to the large language model until an acceptable output is achieved.

2. The method of claim 1, further comprising:
sorting a plurality of portions of the relevant context according to relevance; and
providing the select portion and each subsequent portion iteratively in order of relevance.

3. The method of claim 1, further comprising:
tracking a final amount of context used to achieve the acceptable output; and
using the final amount of context in response to a subsequent query topically similar to the particular query.

4. The method of claim 1, wherein fetching comprises:
fetching the relevant context from a knowledge base.

5. The method of claim 1, wherein the particular query comprises a user query.

6. The method of claim 1, wherein determining the unacceptable output comprises:
determining user dissatisfaction with the output.

7. The method of claim 6, wherein determining user dissatisfaction comprises:
receiving a user selection regarding satisfaction.

8. The method of claim 6, wherein determining user dissatisfaction comprises:
receiving a conversational indication from a user regarding satisfaction.

9. The method of claim 1, determining the unacceptable output comprises:
receiving an indication from a verification system that the output has been deemed unusable.

10. The method of claim 9, wherein the verification system is external to the device.

11. An apparatus, comprising:
one or more network interfaces to communicate with a network;
a processor coupled to the one or more network interfaces and configured to execute one or more processes; and
a memory configured to store a process that is executable by the processor, the process comprising:
fetching relevant context responsive to a particular query initially submitted into a large language model without additional context;
determining that an output from the large language model for the particular query is an unacceptable output;
providing, responsive to the unacceptable output, a select portion of the relevant context to the large language model for a subsequent output; and
increasing, progressively and responsive to subsequent unacceptable outputs from the large language model, an amount of context in each subsequent portion iteratively provided to the large language model until an acceptable output is achieved.

12. The apparatus of claim 11, further comprising:
sorting a plurality of portions of the relevant context according to relevance; and
providing the select portion and each subsequent portion iteratively in order of relevance.

13. The apparatus of claim 11, further comprising:
tracking a final amount of context used to achieve the acceptable output; and
using the final amount of context in response to a subsequent query topically similar to the particular query.

14. The apparatus of claim 11, wherein fetching comprises:
fetching the relevant context from a knowledge base.

15. The apparatus of claim 11, wherein the particular query comprises a user query.

16. The apparatus of claim 11, wherein determining the unacceptable output comprises:
determining user dissatisfaction with the output.

17. The apparatus of claim 16, wherein determining user dissatisfaction comprises:
receiving a user selection regarding satisfaction.

18. The apparatus of claim 16, wherein determining user dissatisfaction comprises:
receiving a conversational indication from a user regarding satisfaction.

19. The apparatus of claim 11, determining the unacceptable output comprises:
receiving an indication from a verification system that the output has been deemed unusable.

20. A tangible, non-transitory, computer-readable medium storing program instructions that cause a device to execute a process comprising:
fetching relevant context responsive to a particular query initially submitted into a large language model without additional context;
determining that an output from the large language model for the particular query is an unacceptable output;
providing, responsive to the unacceptable output, a select portion of the relevant context to the large language model for a subsequent output; and
increasing, progressively and responsive to subsequent unacceptable outputs from the large language model, an amount of context in each subsequent portion iteratively provided to the large language model until an acceptable output is achieved.
